(19) United States
(12) Patent Application Publication
(10) Pub. No.: US 2025/0368522 A1
(43) Pub. Date: Dec. 4, 2025

(54) MULTI-OPERATION PROCESSING OF LITHIUM SOLUTION

(71) Applicant: ACE GREEN RECYCLING INC., Houston, TX (US)

(72) Inventors: Avijit Gautam, Noida (IN); Mayankkumar Mohanbhai Patel, Kheda (IN); Kavaiya Ashish Rajeshkumar, Vadodara (IN)

(73) Assignee: ACE GREEN RECYCLING INC., Houston, TX (US)

(21) Appl. No.: 19/086,110

(22) Filed: Mar. 20, 2025

Related U.S. Application Data
(63) Continuation-in-part of application No. 18/762,965, filed on Jul. 3, 2024.
(60) Provisional application No. 63/652,489, filed on May 28, 2024.

(51) Int. Cl. C01D 15/08; C22B 3/02; C22B 3/22; C22B 3/44; C22B 7/00; C22B 26/12; H01M 10/54

(52) U.S. Cl. CPC C01D 15/08; C22B 3/02; C22B 3/22; C22B 3/44; C22B 7/006; C22B 26/12; H01M 10/54

(57) ABSTRACT

Disclosed is a single chamber (or “single-cylinder”) system and method for iteratively-continuous multi-operation processing of lithium-rich solutions to recover usable lithium (namely in the form of lithium carbonate) via facilitated ion exchange with sodium carbonate to seamlessly perform various processing steps-which may include heating, mixing, precipitating, separating/filtering, and/or drying—and thereby reducing the need for separate processing equipment and improving overall processing efficiency.

### CROSS-REFERENCE TO RELATED APPLICATION(S)

This application claims benefit of and priority to, and incorporates by reference herein in its entirety, U.S. patent application Ser. No. 18/762,965, filed Jul. 3, 2024, titled “RECOVERY OF LITHIUM CARBONATE FROM BLACK MASS” (Attorney Docket No. AGR2404US1U, which in turn claims benefit of and priority to, and incorporates by reference therein in its entirety, U.S. Provisional Application No. 63/652,489, filed May 28, 2024, titled “SYSTEMS AND METHODS FOR LITHIUM-FIRST BATTERY RECYCLING” (Attorney Docket No. AGR2400US0P).

### BACKGROUND

To date recycling of lithium-ion batteries (LIBs) has largely focused on prioritizing and maximizing the recovery of the other node metals—for example, the nickel, manganese, and cobalt of NMC LIBs, and the iron and phosphate of LFP LIBs-over the recovery of lithium. More specifically, recovering the other node metals first from LIBs during recycling decreases the amount of lithium that can be recovered because of a significant portion of lithium-sometimes as much as 30% of the total lithium—is lost as impurities when the other node metals are recovered first.

To address this issue, recent innovation has resulted in exemplary approaches for the recovery of lithium from LIBs (and specifically the black mass generated therefrom) before recovery of individual metal-oxides during LIB recycling. For certain such approaches, the black mass from the LIBs may be processed so as to produce a lithium-rich solution that is physically separable from the other node metals but may still need to be further processed to produce a usable lithium compound. For example, a lithium solution may be combined with sodium carbonate (Na2CO3) to facilitate a lithium-sodium (Li—Na) ion exchange with regard to the carbonate ion (CO3) thereof and thereby produce usable lithium carbonate (Li2CO3) which can be precipitated from the solution.

However, conventional approaches to recovering lithium carbonate (Li2CO3) from a lithium-rich solution can be cumbersome, energy-intensive, and time-consuming, making such approaches generally inefficient and requiring several sequential subprocesses such as solution mixing, precipitation, separation/filtration, and drying operations to produce usable lithium carbonate (Li2CO3) in relatively-pure form. Accordingly, there is a need for a more efficient means for recovering lithium carbonate (Li2CO3) from lithium-rich solutions, and for doing so at an industrial scale and/or in an automated fashion.

### SUMMARY

Various implementations disclosed herein are directed to systems, methods, and other utilizations for recovering lithium in the form of lithium carbonate (Li2CO3) from lithium-rich (Li+) solutions utilizing a single chamber (or “single-cylinder”) to seamlessly perform various processing steps—which may include heating, mixing, precipitating, separating/filtering, and/or drying—and thereby reducing the need for separate processing equipment and improving overall processing efficiency.

More specifically, various implementations disclosed herein are directed to methods for recovering a lithium (Li) end-product from a lithium-rich (Li+) solution, the method comprising: combining, within a cylinder, the lithium-rich (Li+) solution with a sodium carbonate (Na2CO3) solution to enable precipitation of solid lithium carbonate (Li2CO3) and producing a resultant sodium-rich (Na+) solution; and separating, within the cylinder, the solid lithium carbonate (Li2CO3) from a resultant sodium-rich (Na+) solution.

Several such implementations may further comprise features for: introducing the lithium-rich (Li+) solution into the cylinder, heating the lithium-rich (Li+) solution to within a target temperature range, and introducing the sodium carbonate (Na2CO3) solution into the cylinder, wherein the target temperature range is between 55 degrees C. and 115 degrees C., the target temperature range is between 65 degrees C. and 105 degrees C., the target temperature range is between 75 degrees C. and 95 degrees C., the target temperature range is between 80 degrees C. and 85 degrees C., the target temperature range is between a first temperature and a second temperature where the latter is no more than 60 degrees C. greater than the first temperature, the target temperature range is between a first temperature and a second temperature where the latter is no more than 20 degrees C. greater than the first temperature, and/or the target temperature range is between a first temperature and a second temperature where the latter is no more than 10 degrees C. greater than the first temperature.

Certain such implementations may also further comprise features whereby: the sodium carbonate (Na2CO3) solution is a 20%-30% concentration sodium carbonate (Na2CO3) solution; a ratio of the lithium-rich (Li+) solution to the sodium carbonate (Na2CO3) solution within the cylinder is between 1:1 and 3.1 (for example, 3:1); a ratio of the lithium-rich (Li+) solution to the sodium carbonate (Na2CO3) solution within the cylinder is maintained to be between 1:1 and 3.2:1 (for example, between 2.8:1 and 3.2:1); separating the solid lithium carbonate (Li2CO3) from a resultant sodium-rich (Na+) solution is achieved using a filter that prevents passage therethrough of the solid lithium carbonate (Li2CO3) but permits the resultant sodium-rich (Na+) solution to pass therethrough; introducing positive pressure into the cylinder to promote passage of the resultant sodium-rich (Na+) solution through the filter, the post-filter output of which provides a corresponding pressure release from the cylinder; introducing positive pressure into the cylinder is achieved at least in part by introducing air into the cylinder; and/or the air is heated within the cylinder to promote drying of the lithium carbonate (Li2CO3) within the cylinder.

Furthermore, various implementations disclosed herein also may be directed to system for recovering a lithium (Li) end-product from a lithium-rich (Li+) solution, the system comprising: a single-cylinder for receiving and mixing the lithium-rich (Li+) solution with a sodium carbonate (Na2CO3) solution to enable precipitation of solid lithium carbonate (Li2CO3) and producing a resultant sodium-rich (Na+) solution; and a filter, within the single-cylinder, to separate the solid lithium carbonate (Li2CO3) from the resultant sodium-rich (Na+) solution. Several such implementations may further comprise: a heating jacket substantially surrounding the single-cylinder for heating internal contents of the single-cylinder; at least one input line into the single-cylinder for the lithium-rich (Li+) solution and the sodium carbonate (Na2CO3) solution; at least one output line out of the single-cylinder for the resultant sodium-rich (Na+) solution; and/or at least one input line for a positive-pressure air supply into the single-cylinder.

In addition, various implementations disclosed herein may be directed to an apparatus for recovering a lithium (Li) end-product from a lithium-rich (Li+) solution, the system comprising: a single-chamber capable of receiving, mixing, and enabling heating of the lithium-rich (Li+) solution and a sodium carbonate (Na2CO3) solution to enable precipitation of solid lithium carbonate (Li2CO3) and producing as a by-product a resultant sodium-rich (Na+) solution; and a filter subsystem within the single-cylinder means capable of separating the solid lithium carbonate (Li2CO3) from the resultant sodium-rich (Na+) solution and removing the resultant sodium-rich (Na+) solution from the single-chamber while retaining and drying the solid lithium carbonate (Li2CO3) within the single-chamber.

This summary is provided to introduce a selection of concepts in a simplified form that are further described below in the detailed description. This summary is not intended to identify key features or essential features of the claimed subject matter, nor is it intended to be used to limit the scope of the claimed subject matter, nor is it an admission that any of the information provided herein is prior art to the implementations described herein.

### BRIEF DESCRIPTION OF THE DRAWINGS

The foregoing summary and the following detailed description of illustrative implementations are better understood when read in conjunction with the appended drawings. For the purpose of illustrating the implementations, there is shown in the drawings example constructions of the implementations; however, the implementations are not limited to the specific methods and instrumentalities disclosed. In the drawings:

FIG. 1 is a process flow diagram illustrating an exemplary approach for “lithium first” LIB recycling representative of the various implementations disclosed herein;

FIG. 2 is a modified block diagram illustrating an exemplary system for “lithium-first” LIB recycling representative of the various implementations disclosed herein;

FIG. 3 is a process flow diagram illustrating an exemplary approach for targeted recovery of graphite from black mass representative of the various implementations disclosed herein;

FIG. 4 is a modified block diagram illustrating an exemplary system for targeted recovery of graphite from black mass representative of the various implementations disclosed herein;

FIG. 5 is a process flow diagram illustrating an exemplary approach for roasting a black mass nitratenated slurry representative of the various implementations disclosed herein;

FIG. 6 is a modified block diagram illustrating an exemplary system for roasting a black mass nitratenated slurry representative of the various implementations disclosed herein;

FIG. 7 is a process flow diagram illustrating an exemplary approach for the recovery of lithium from black mass before recovery of individual metal-oxides representative of the various implementations disclosed herein;

FIG. 8 is a modified block diagram illustrating an exemplary system for the recovery of lithium from black mass before recovery of individual metal-oxides representative of the various implementations disclosed herein;

FIG. 9 is a modified block diagram illustrating an exemplary system for continuous multi-operation processing for recovery of lithium compounds from a lithium-rich solutions representative of various implementations disclosed herein;

FIG. 10 is a process flow diagram illustrating an exemplary approach for continuous multi-operation processing for recovery of lithium compounds from a lithium-rich solutions representative of various implementations disclosed herein; and

FIG. 11 is a block diagram of an example computing environment that may be used in conjunction with any of the various implementations and aspects herein disclosed.

### DETAILED DESCRIPTION

Lithium-ion batteries (LIBs) are widely used in many different applications, from power-production storage and electric vehicles to backup power supplies and batteries found in a variety of personal portable electronic devices. Generally, LIB batteries comprise both node materials (that is, the materials found in anodes and cathodes of batteries) and non-node materials (battery materials not part of the anode or cathode). As such, the node materials in LIBs generally comprise graphite, lithium, and other node metals, the latter being specific to the metallic composition of the cathode in the LIB.

Although LIBs may have different “chemistries” (that is, differing cathode and anode material compositions) the two most common types of LIBs are nickel-manganese-cobalt (NMC) batteries and lithium-iron-phosphate (LFP) batteries. As their names suggest, the node materials of NMC LIBs include graphite, lithium, nickel, manganese, and cobalt (and may also include iron, silicon, and/or carbon)—specifically, a graphite anode and a cathode comprising lithium, nickel, manganese, and cobalt (e.g., a blend of LiNiO₂ plus LiMnO₂ plus LiCoO₂ collectively represented by the chemical formula LiNixMnyCozO₂ where x+y+z equals 1) while the node materials of LFP LIBs include graphite, lithium, iron, and phosphate (and may also include manganese)—specifically, a graphite anode and a cathode comprising lithium, iron, and phosphate (e.g., LiFePO4).

Today the majority of LIBs are still mostly constructed from new materials stemming from the mining and refining of new lithium and other “node metals” (the specific metals used in the anode and cathode of the LIBs). Similarly, the majority of LIBs—and especially small-form-factor LIBs used in personal devices and the like—are disposed of in landfills when they reach the end of their useful life. However, there is a growing need for recycling LIBs to both recapture the valuable components therein and decrease the need for new materials, as well as to achieve environmental advantage from reducing waste and avoiding landfills plus the benefits of decreased mining and refining of new materials.

For a variety of reasons, LIB recycling has largely focused on maximizing the recovery of graphite or the recovery of the other node metals—for example, the nickel, manganese, and cobalt of NMC LIBs, and the iron and phosphate of LFP LIBs-which decreases the amount of lithium that can be recovered because of the portion of lithium, sometimes as much as 30% of the total lithium, that is lost as impurities in the other node metals when recovered first. More specifically, when recycling LIBs, the extraction of specific components from the resulting black mass is somewhat imperfect in that any particular component extracted from the mix of components found in the black mass may inherently include small amounts of the other materials present in the black mass. For example, if the cobalt metal component is extracted first from the black mass of an NMC LIB, some small portion of nickel, manganese, and lithium may still adhere to (and/or otherwise be removed with) the cobalt when separated and removed from the black mass. Conversely, some small amount of cobalt may also remain behind in the black mass, although this amount of cobalt left behind in the black mass may be comparatively less than the residual amounts of the other components that are removed with the cobalt and which are impurities in the cobalt so removed.

As such, the first component removed may have the highest recovery percentage of the target metal but may also be the most impure because of the residual amounts of the other components that have adhered thereto, while the last component removed from the black mass—or what is left at the end when all other components have been removed—may have the lowest recovery percentage (due to the material lost during preceding extraction of the other components), but this last component may also be of the highest relative purity compared to the earlier-recovered components.

Because the first component recovered from LIB black mass will generally have the relatively highest percentage of recovered material from the total amount of that particular material found in the black mass—by virtue of being first removed-almost none of such first component will be lost during the individual recovery of other components (for which recovery is subsequent and has not yet occurred). Thereafter, when the second component is recovered, it may be comparatively less complete (i.e., lower relative percentage of recovered material from that available in the black mass) because of the lost portion of the second component inadvertently removed during recovery of the first component (and which is an impurity in the removed first component). This trend continues for each subsequently removed component (third, fourth, fifth, etc.) until what remains is the last component (or combination of components) which may have the relatively most material lost during recovery of the other preceding components, but which also may be relatively purer than the earlier-removed components.

Today almost all known methodologies for LIB recycling focus on the extraction of metals from black mass before the recovery of lithium, which results in relatively pure lithium but the relatively lowest yield because of amounts lost with the removal of the other metals (as impurities in such removed metals). This is partly due to a number of different factors including, for example, what may be the relatively higher value of the other component metals compared to lithium—and thus an intentional desire for higher recovery percentages and lesser loss of these components—but the ubiquitousness of this approach also reflects the lack of known or utilized alternative processes for recovering lithium first. Consequently, a certain amount of lithium is lost during metal extraction, such as in the form of lithium residue adhering to each of the other target metals when extracted from the black mass (e.g., cobalt, nickel, and manganese for an NMC LIB). As a result, a relatively larger amount of lithium may be lost during LIB recycling due to the other component metals being extracted first and taking with each of them a small amount of lithium as an inherent impurity, thereby diminishing the overall amount of lithium left to be recovered at the end of the process.

However, there are several distinct advantages to recovering lithium before recovering the other metal components in an LIB. First, by removing the lithium at the outset, before removing the other metals, the resulting purity of the other recovered metals may be higher and thus provide a greater value versus a larger amount of less pure metals. Second, given the inherent detriments and risks that unrecovered lithium poses to the environment, achieving a higher percentage recovery of lithium is more environmentally sound and may be or may become necessary to meet ever-tightening environmental regulations. Third, when lithium is recovered first, the resulting metals (e.g., cobalt, manganese, and nickel) in their unseparated and unrefined forms (e.g., as an alloy thereof) have a market value and a market demand that may not require further processing and indirectly provide even greater economic benefit (which may not be the case for such a mix of metals when lithium is still present therein). Lastly, the extraction of lithium before the other target metals may also enable the utilization of new and better, more efficient, lower cost, and/or more environmentally friendly processes than those utilized in current existing lithium-last (or lithium-later) recovery processes for LIB recycling.

Accordingly, disclosed herein are various implementations featuring systems and methods related to the production of solid lithium carbonate (Li2CO3) from a lithium-rich solution that may result from battery recycling operations or from other sources or utilizations. These various implementations may be particularly useful for new and innovative “lithium-first” recovery in LIB recycling, as well as any of several other applications where it is necessary to extract lithium carbonate from a lithium-rich solution. The various examples provided herein for recovery of solid lithium carbonate from a lithium-rich solution are not intended to limit these various implementations to only such uses, but are instead intended to explain the various implementations without being limited to such implementations. In other words, although certain instances of these implementations may be described for specific recycling of one type of LIB (e.g., NMC LIBs comprising nickel, manganese, and cobalt and/or LFP LIBs comprising iron and phosphate), such descriptions are also explicitly intended to apply to all types of LIBs as well as other lithium-based batteries, other batteries using alternatives to lithium, or other recyclables to which such processes could be applied, and nothing herein is intended to limit such processes to any single LIB type but, instead, should be broadly interpreted for all such possible implementations as will be well-understood and readily-appreciated by skilled artisans.

Furthermore, an understanding of various concepts is helpful toward a broader and more complete understanding of the various implementations disclosed herein, and skilled artisans will readily appreciate the implications these various concepts have on the breadth and depth of the various implementations herein disclosed. And while the several and various implementations disclosed herein may be described as specifically pertaining to or directed to use in recycling of lithium-ion batteries (LIBs) and/or recovery of node metals therefrom, such implementations may be equally applied to the recovery of other metals and/or other metal sources. Accordingly, nothing herein is intended to limit the various implementations solely to LIB recycling or node metal recovery but, instead, the various implementations disclosed herein may be applied to a variety of different processes and operations, and thus the disclosures made herein should be read as broadly as possible as applied to a variety of different utilizations.

Moreover, certain terms used herein may also be used interchangeably with other terms used herein and such terms should be given the broadest interpretation possible unless explicitly noted otherwise. For example, as used herein the terms electrolysis, electrowinning, and electrorefining should be treated as interchangeable terms such that where one term is used the other terms are also implied, and thus any use of the term electrolysis should be understood to also include electrowinning and electrorefining except where explicitly differentiated. Moreover, as used herein the term “electrolytic processes” (and variations thereof) is explicitly intended to include and encompass electrolysis, electrowinning, and electrorefining, each individually and collectively.

Additionally, as will be readily appreciated and well-understood by skilled artisans, substances that might typically be represented by their chemical compositions using subscripted numbers-such as gaseous oxygen (O₂), water (H₂O), and so forth—may instead be represented herein with regular numbers in lieu of subscripted numbers (i.e., as O₂ for gaseous oxygen, H₂O for water, and so forth) as the same and equivalent as if subscripted numbers were utilized, and no distinction should be made as to the use of regular numbers versus the use of subscripted numbers anywhere herein.

As used herein (both heretofore and hereafter), the term “near-pure” shall mean a purity comparable to within 90% of the average purity obtainable by traditional smelting processes. Likewise, the term “pure” shall mean a purity that is equal to or exceeds the typical purity level obtainable by traditional processes known and appreciated by skilled artisans, and the term “perfect purity” shall mean a purity that is 99.000% comprised of the elemental metal without regard to natural surface oxidation or hydroxidation. Accordingly, for all implementations disclosed herein for obtaining “near-pure” metal, such disclosures should be deemed to also disclose alternative implementations for obtaining “pure” and “perfectly pure” metals as well. Also as used herein, the term “recovery” and other equivalent terms (e.g., purification, derivation, etc.) shall refer to the obtaining of a purer metal (e.g., elemental lead) from a less pure form of said metal (e.g., lead oxides), metal compounds, or metal mi3s, by any physical, chemical, electrolytical, or other purification processes.

With regard to the various components making up LIBs, the anodes and cathodes may be collectively referred to herein simply as “nodes,” and terms characterized by the term “node” such as “node metals” or “node materials” refer to both anode and cathode materials. Likewise, the term “non-node” and variations thereof refer to battery components other than those constituting the anodes and cathodes. Similarly, the term “black mass” shall refer to the mix of node materials resulting from battery breaking after the removal of non-node materials (which, prior to such removal, may be more generally referred to simply as the “mass”) and, for convenience, black mass may continue to refer to such material throughout removal of components therefrom. For example, black mass from which graphite is removed may still be referred to as black mass until only a single component or equivalent remains, and that this minor imprecision is not in any way intended to limit the disclosure herein. Similarly, when an element is removed from the black mass, it is presumed that some portion of the other components may also be inadvertently removed (as an impurity to that which is removed) and that some portion of the component removed is also inadvertently left behind (as an impurity to that which is left behind), but these residual amounts (as impurities) are ignored for purposes of describing the various implementations herein. For example, when a component (such as graphite) is described as being removed (or any similar term) from a source (e.g., the black mass), it should be understood as meaning “substantially removed” in an amount greater than 50% (and often much greater) of that component present in the source from which it is being removed with the remainder being inadvertently (or inevitably) left behind as a residual impurity, and vice versa with regard to impurities inadvertently (or inevitably) removed with the target component.

Based on these understandings and parameters for proper interpretation of the disclosures made herein, skilled artisans will well-understand and readily-appreciate the breath and scope of the various implementations herein disclosed.

### Lithium-First Battery Recycling

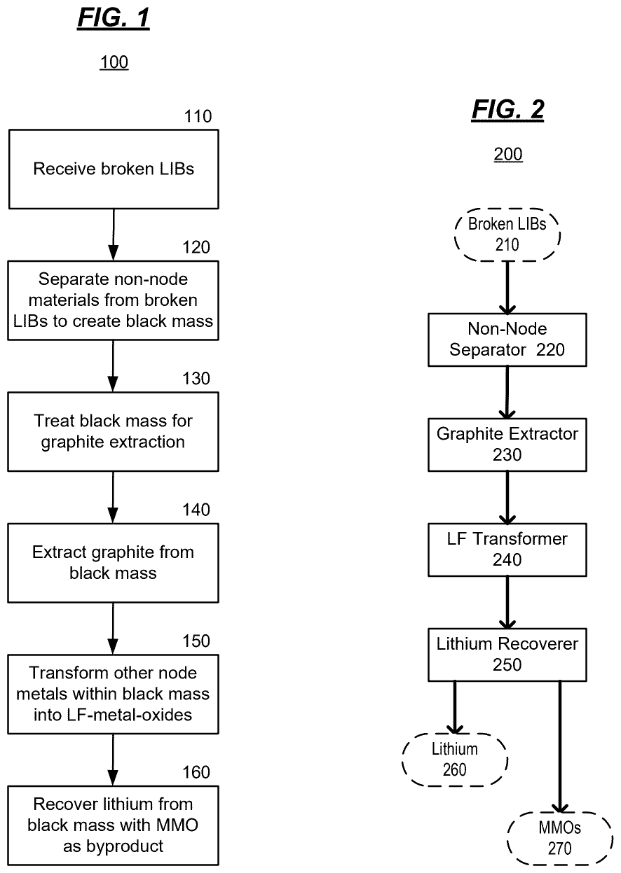

FIG. 1 is a process flow diagram 100 illustrating an exemplary approach for “lithium-first” LIB recycling representative of the various implementations disclosed herein. In FIG. 1, at 110 broken LIBs are received and, at 120, the non-node materials (e.g., aluminum, copper, polypropylene, steel, and so forth in any of several different forms) may be separated therefrom to create black mass comprising the node materials (e.g., graphite, lithium, and other node metals in any of several different forms). At 130 the black mass may then be chemically treated (e.g., treated with nitric acid, that is, “nitratenated” or “nitrated,” as described in greater detail later herein) to facilitate, at 140, the extraction of the graphite from the black mass. At 150 the resultant black mass (now graphite free) may be further processed to transform the other node metals into lithium-free metal oxides (referred to herein as “LF-metal-oxides”), effectively separating the lithium atomically from the other node metals and metal compounds within the black mass. Then at 160 the lithium is recovered from the black mass with the latter comprising multi-metal-oxides (MMO) as a “byproduct” (i.e., as a separate resultant product), said MMO comprising two or more metal oxides that could be further refined into individual metal-oxides (IMO)—such as through leaching or other known processes—or repurposed or sold as—is without further refining.

FIG. 2 is a modified block diagram 200 illustrating an exemplary system for “lithium-first” LIB recycling representative of the various implementations disclosed herein. As shown in FIG. 2, broken LIBs 210 are inputs received by the non-node separator 220 for separating the non-node metals from the broken LIBs to create black mass. The non-node separator 220 is operably coupled to a graphite extractor 230 for extraction of the graphite from the black mass. The graphite extractor 230 is operably coupled to the LF Transformer 240 for transforming the other node metals in the black mass into lithium-free (“LF”) metal oxides, that is, LF-metal-oxides. The LF Transformer 240 is operably coupled to the lithium recoverer 250 which then recovers and outputs the lithium 260 as well as the MMO 270 as a byproduct for further refining into the individual metal oxides (or pure metals), or alternatively disposes of the MMOs in some other fashion (such as sale for use by a third party interested in the MMO as-is).

### Targeted Graphite Removal

After non-node materials are removed from the broken LIBs (per 120 of FIG. 1), the resultant black mass has an abundance of graphite, the removal of which may facilitate efficient and cost-effective subsequent elements in “lithium-first” processing (corresponding to 130 and 140 of FIG. 1).

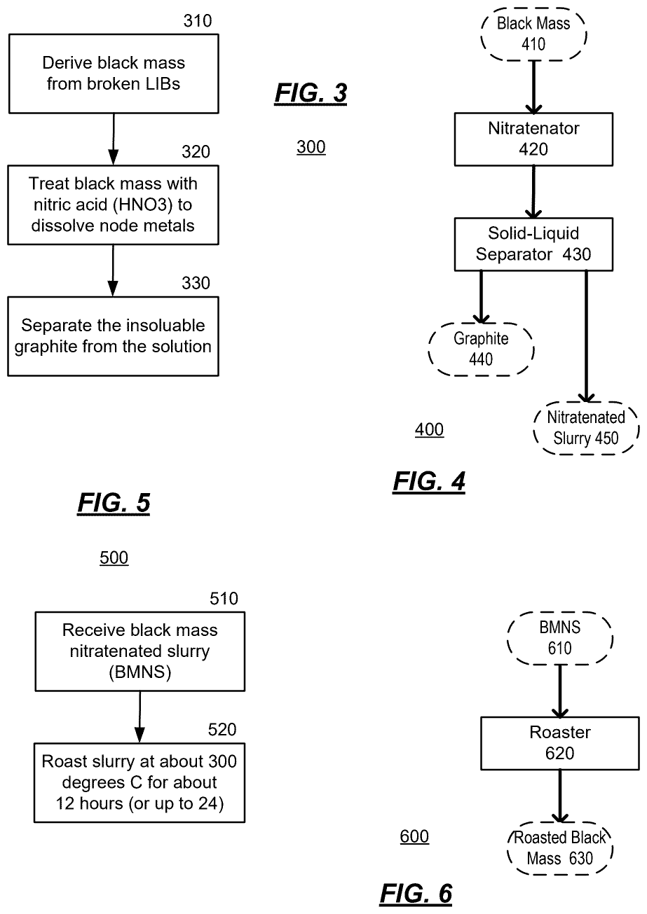

FIG. 3 is a process flow diagram 300 illustrating an exemplary approach for targeted recovery of graphite from black mass representative of the various implementations disclosed herein. In FIG. 3, and after black mass is derived from the broken LIBs at 310—wherein the removed non-node components may include iron, steel, aluminum, copper, and/or polypropylene, among other materials—at 320 the black mass is treated with nitric acid (HNO₃) to dissolve the lithium and other node metals to form a solution (i.e., become liquid) whereas the graphite is insoluble in nitric acid (HNO₃) and remains solid, or at least does so at relatively low temperatures. This, in turn, enables the solid graphite to be separated from the liquid solution at 330, the latter now comprising the remaining black mass as a nitratenated slurry.

As previously discussed, initially deriving the black mass comprises removing non-node components from the mass of broken LIBs such that the black mass substantially comprises graphite, lithium, and the other node metals (albeit with residual amounts of non-node materials as inherent impurities that are here acknowledged but can be otherwise ignored). Regardless, one advantage to this approach is that the black mass may be treated with the nitric acid (HNO₃) without the need for any external heating (although some degree of natural heating may result from the chemical reactions resulting from the combination). It may also be preferable for the nitric acid (HNO₃) treatment to last for a period of time no less than four hours and no more than 24 hours—such as for roughly (or exactly) five hours or six hours—before removing the graphite to maximize both the amount of graphite recovered and minimize the loss of other materials from the black mass as impurities in the removed graphite. Once the graphite is separated (and dried if necessary), the separated graphite may be utilized in the production of new anodes or for any other related or unrelated use. Regardless, this foregoing process may be applicable to black mass derived from nickel-manganese-cobalt (NMC) batteries, lithium-iron-phosphate (LFP) batteries, or both.

FIG. 4 is a modified block diagram 400 illustrating an exemplary system for targeted recovery of graphite from black mass representative of the various implementations disclosed herein. As illustrated in FIG. 4, the system may comprise a nitratenator 420 for receiving the black mass and for treating it with nitric acid (HNO₃) to dissolve the lithium and the one or more other node metals to form a solution while the graphite (again, insoluble in nitric acid (HNO₃)) remains solid. The nitratenator 420 then may be operably coupled to a solid-liquid separator 430 for physically separating the graphite 440 from the solution 450, said solution 450 being a nitratenated (or nitrated) slurry of the black mass nitrate solution.

### Variable Temperature Processing (“Roasting”)

After the graphite is removed from the black mass nitrate solution in the form of a nitratenated (or nitrated) slurry (per FIGS. 3 and 4), this solution can then be roasted at specific temperatures for specific durations to facilitate chemical reactions within the slurry to enhance atomic separation of the lithium from the other node metals. More specifically, the slurry may be roasted at a temperature of up to or about 300 degrees C. for twelve (12) hours (or, alternatively, up to 24 hours) to achieve beneficial effects, although other temperatures and times may also yield other intended results based on specific needs, component elements in the slurry, purity of the slurry, volume of the slurry, and a host of other factors.

FIG. 5 is a process flow diagram 500 illustrating an exemplary approach for roasting a black mass nitratenated slurry (BMNS) representative of the various implementations disclosed herein. In FIG. 5, after treating the black mass with nitric acid (HNO₃) to dissolve lithium and the other node metals to form a solution, and after separating the graphite from the solution, at 510 the BMNS is received and, at 520, is roasted for approximately twelve (12) hours (or, alternatively, up to 24 hours) at a temperature of up to or about 300 degrees C. to facilitate chemical reactions within the slurry to enhance atomic separation of the lithium from the other node metals. Although the roasting may be performed at temperatures between 150 degrees C. and 350 degrees C. for a duration of no less than 9 hours and no more than 24 hours, more beneficial roasting may be achieved if performed at temperatures between 290 degrees C. and 310 degrees C. for a duration of no less than 11 hours and no more than 25 hours.

FIG. 6 is a modified block diagram 600 illustrating an exemplary system for roasting a black mass nitratenated slurry representative of the various implementations disclosed herein. As illustrated in FIG. 6, the system may comprise a roaster 620 for receiving the BMNS 610 as input and producing roasted black mass 630 as the output. Similar to other components described elsewhere herein, the roaster 620 may be automated to control both time and temperature plus any of several additional features that will be apparent to skilled artisans.

### Recovery via Lithium Carbonate

After the black mass is roasted and the lithium therein is freed or unbound from the other node metals in the black mass (per FIG. 5 and FIG. 6)—said black mass now comprising lithium compounds and multiple other metal-oxides in the form of a blend of said multi-metal-oxides (MMO)—the lithium is ready to be recovered before any of the individual metal-oxides (IMOs) are derived from the MMO (if at all).

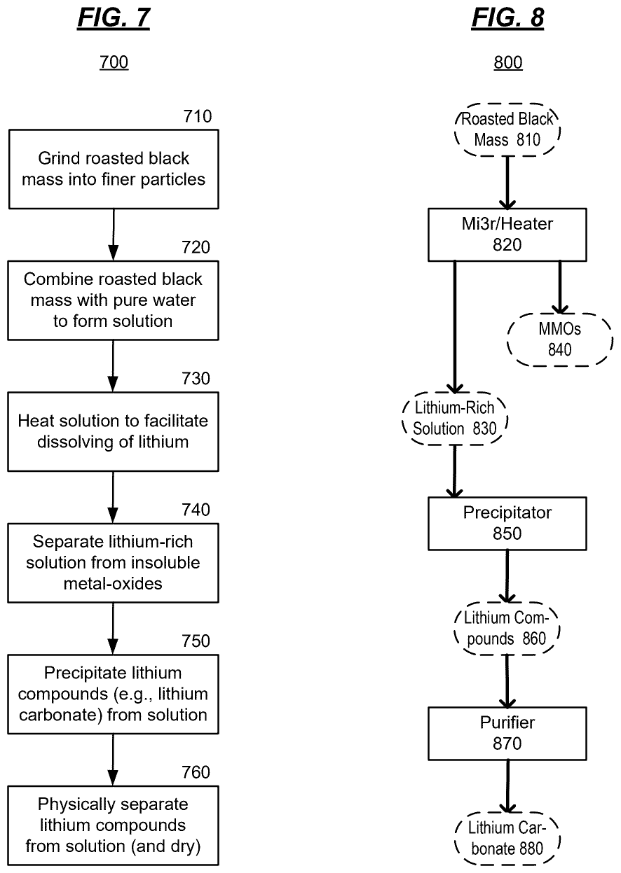

FIG. 7 is a process flow diagram 700 illustrating an exemplary approach for the recovery of lithium from black mass before recovery of individual metal-oxides representative of the various implementations disclosed herein. In FIG. 7, at 710 the roasted black mass is ground into finer particles and, at 720, the finer particles of black mass are combined with pure water to form a lithium solution. At 730 the lithium solution may be heated to facilitate the water dissolving the lithium compounds from the roasted black mass. At 740 the dissolved lithium solution may be drawn off and/or the insoluble metal-oxides may be physically separated from the solution. At 750 the lithium solution may then be treated with sodium carbonate (Na2CO3) to precipitate lithium compounds from the solution and, at 760, the lithium compounds may be further treated using any of known means for specifically extracting lithium carbonate (Li2CO3) therefrom and/or with the remainder reconstituted as sodium carbonate (Na2CO3).

In this manner, recovery of the lithium from the black mass occurs before recovery of the other node metals from the black mass and, conversely, the recovery of the other node metals from the black mass occurs after recovery of the lithium or, alternatively, said metal-oxides may be maintained as a multi-metal-oxide (MMO) compound without further recovery of the individual metal-oxides therein (or subsequent recovery thereof substantially after the fact). For certain implementations the combination of black mass and water may be maintained at a temperature of between 70 degrees C. and 99 degrees C. for no less than two hours (or, alternatively, no less than thirty minutes) and no more than five hours, while for certain alternative implementations the combination of black mass and water may be maintained at a temperature of between 80 degrees C. and 90 degrees C. for no less than three hours (or, alternatively, no less than thirty minutes) and no more than four hours.

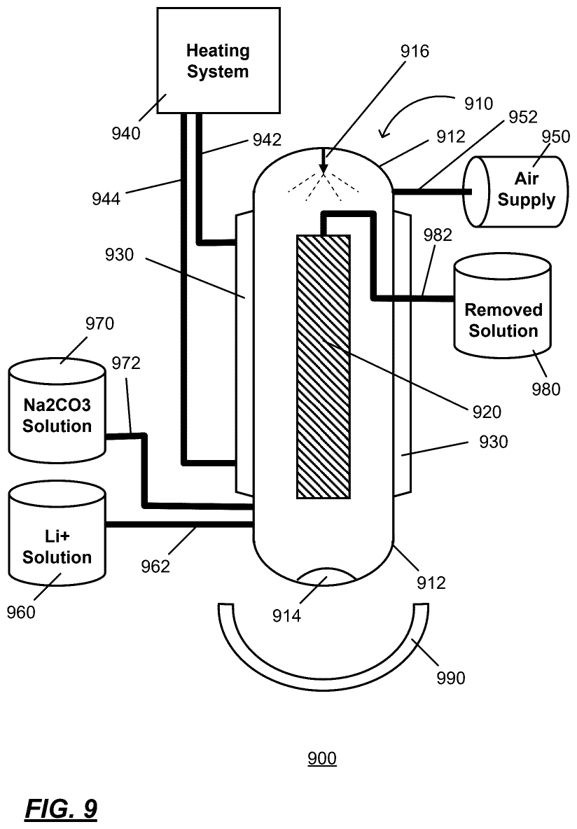

FIG. 8 is a modified block diagram 800 illustrating an exemplary system for the recovery of lithium from black mass before recovery of individual metal-oxides representative of the various implementations disclosed herein. As illustrated in FIG. 8, the system comprises a mi3r/heater 820 for receiving the roasted black mass 810 as input and then separating the lithium (as a solution) from the insoluble node metal-oxides in the form of an MMO, and thus the lithium (as a solution) is separated from the black mass before any individual metal-oxide is derived therefrom. The lithium solution 830 may then be further processed by a precipitator 850 to precipitate a resulting lithium compound 860 from the solution which, in turn, may be further purified by the purifier 870 to produce lithium carbonate 880.

### Multi-Operation Processing

Various implementations disclosed herein are directed to a one-shared-chamber (or “single-cylinder”) system and method for enabling iteratively-continuous multi-operation processing to recover lithium from lithium-rich solutions such as those resulting from any of the previous processes described herein above (e.g., lithium solution 830) or derived from other sources. The system and method seamlessly integrate various processing steps-which may include heating, mixing, precipitating, separating/filtering, and/or drying-into a single-cylinder continuously-iterative multi-step automated operation, thereby reducing the need for separate processing equipment and improving overall processing efficiency.

More specifically, the system enables the complete recovery of usable lithium—in the form of lithium carbonate (Li2CO3) for example—within one shared processing chamber that minimizes waste and promotes sustainability as well as enables operations at industrial scales. The system also significantly reduces energy consumption and processing time, making it both cost-effective and environmentally-friendly. By revolutionizing the recovery of usable lithium—and in particular solid/dry lithium carbonate—the system may be utilized not just by industries engaged in battery recycling but also those directed to chemical manufacturing, ore processing, and/or other metal recovery operations, for example. While the various implementations disclosed herein may be described as iteratively-continuous (e.g., as a cyclical series of processing steps), alternative implementations may be continuous-and-in-parallel insofar as the some or all of the steps-heating, mixing, and precipitating, for example—may be undertaken simultaneously withing the single chamber after an initiating cycle and possibly forestalling other steps-such as separating/filtering and drying—for cumulative performance during breaks in the continuous parts of the process.

FIG. 9 is a modified block diagram (with a partial cutaway side view) illustrating an exemplary system 900 for iteratively-continuous multi-operation processing for recovery of lithium compounds from a lithium-rich solutions representative of various implementations disclosed herein. As illustrated in FIG. 9, the system 900 may comprise a cylinder 910 with a filter 920 and a heating jacket 930. The filter 920 may be internal and centrally positioned within the cylinder 910, relative to the containing walls 912 (a.k.a., the “encapsulation surfaces”) of the cylinder 910, as shown in the figure. The heating jacket 930 may be external to, relative to the containing walls 912 of the cylinder 910, and substantially surround the cylinder 910 by physically engaging the containing walls 912 as shown in the figure. The cylinder 910 may also comprise an exit door 914 built into a specific section of the containing walls 912, as well as an internal circulation system for drawing liquid contents of the cylinder 910 toward a shower-like spigot 916 and expelling same therefrom (as represented in FIG. 9 as dotted-line liquid streams of liquid emanating from said spigot 916).

The system 900 may further comprise a first tank 960 holding a lithium-rich (Li+) solution and a second tank 970 holding a sodium carbonate (Na2CO3) solution, both tanks being operably coupled to the cylinder 910 via the respective input lines 962 and 972 and through which the solutions from each tank 960 and 970 may be introduced into said cylinder 910. An air supply 950 may be also operably coupled to the cylinder 910 via an airline 952 through which a positive-pressure airflow may be introduced into the cylinder 910. The cylinder 910 may also be operably coupled to a third tank 980 for waste, that is, processed solution exiting the cylinder 910 as well as air introduced from the air supply 950 into the cylinder 910, after both the air and solution pass through the filter 920, said filter 920 operating to permit only air and lithium-free solution to pass therethrough and exit the cylinder 910 via the waste line 982 to the third tank 980. Air may then be vented from the third tank (not shown), rerouted to the air supply 950 (not shown), or otherwise separated from the removed solution and/or the third tank 980. The removed solution, meanwhile, may be disposed of (not shown) or may be recycled by being reintroduced into either the first tank, the second tank, or both (not shown). Conversely, materials that are not able to pass through the filter may be removed from the cylinder via the exit door 914 and collected in the collection tank 990. In addition, one or more bypass valves and corresponding bypass lines (not shown) may be utilized for introducing solution into the cylinder 910 from either or both tanks 960 and 970 or air from the air supply 950, or for removing air or solution from the cylinder 910 to the third tank 980 or elsewhere (not shown).

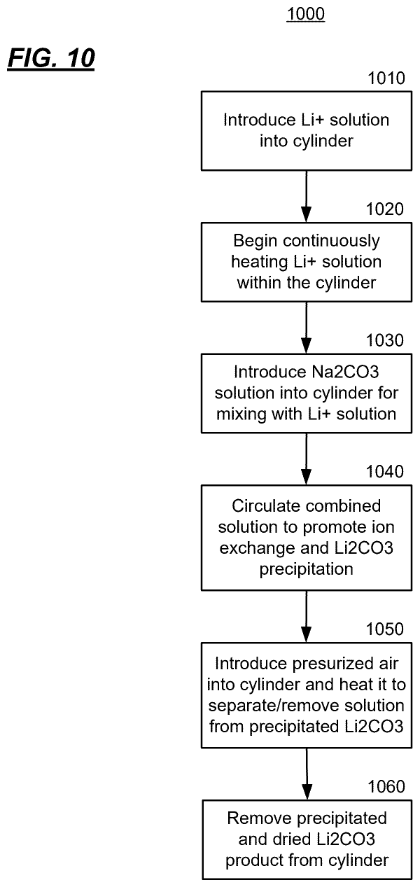

FIG. 10 is a process flow diagram 1000 illustrating an exemplary approach for continuous multi-operation processing for recovery of lithium compounds from a lithium-rich solutions representative of various implementations disclosed herein, including but not limited to utilization of the exemplary system 900 illustrated in FIG. 9. In FIG. 10, the process may commence at step 1010 with the introduction of a lithium-rich (Li+) solution into the cylinder 910. At 1020 the cylinder 910, via operation of the heating jacket 930, may begin continuously heating the lithium-rich (Li+) solution within the cylinder 910 to within a first optimal temperature range. Then, at 1030, a sodium carbonate (Na2CO3) solution may be introduced into the cylinder 910 for mixing with the heated lithium-rich (Li+) solution while heating and maintaining the mixture to within a second optimal temperature range which may be the same as or different than the first optimal temperature range.

At 1040 the resulting combined solutions is then circulated, agitated, and/or further blended or mixed within the cylinder 910 to promote ion exchange and the formation of lithium carbonate (Li2CO3) precipitate (in solid form) with the sodium (Na) ions remaining dissolved in the liquid solution. Once a target threshold of lithium has been precipitated form the solution as lithium carbonate (Li2CO3), at 1050 pressurized air is introduced into the cylinder 910 to force the now sodium-rich (Na+) solution to pass through the filter 920 and out of the cylinder 910 while the precipitated lithium carbonate (Li2CO3), unable to pass through the filter, is retained in the cylinder 910 and effectively dried by the movement of air and exit of solution from the cylinder 910 via the filter 920. At 1060 the dried lithium carbonate (Li2CO3) precipitate end-product may then be removed from the cylinder, which may be achieved utilizing the exit door 914, and collected in the collection tank 990 by any of various known approached that will be well-understand and readily appreciated by skilled artisans.

For various implementations, the lithium-rich (Li+) solution may be circulated within the cylinder 910 until it reaches an optimal temperature range of no less than 75 degrees C. and no greater than 95 degrees C., said range achievable by heating via heating jacket surrounding the cylinder to ensure the solution is heated uniformly and consistently. For various implementations, the lithium-rich (Li+) solution may be blended with a 20-30% concentration sodium carbonate solution at a 3-to-1 ratio (i.e., 75% versus 25% respectively) in order to promote minimal sodium metal remaining in the final lithium carbonate (Li2CO3) product. Generally, the precipitated lithium carbonate (Li2CO3) resulting from the mixing/blending and continuous circulation within the cylinder 910 will be in the form of white crystals while the sodium-rich (Na+) solution by-product will be in the form of a clear liquid.

Notably, the filter 920 is designed to ensure that no precipitated lithium carbonate (Li2CO3) particles transfer to the filtration side of said filter 920, and that only the resulting sodium-rich (Na+) solution passes through the filter 920 to effectively remove the entire resultant sodium-rich (Na+) solution from the cylinder and leaving only dried solid lithium carbonate (Li2CO3) within the cylinder 910 and possibly adhering to the outside surface of the filter 920 itself. Additionally, the air used to remove the resultant sodium-rich (Na+) solution from the cylinder 910 via the filter 920 may be heated with the cylinder 910 by the heating jacket 930 to facilitate drying of the precipitated lithium carbonate (Li2CO3) particles.

As used herein, and unless explicitly stated otherwise, the term “cylinder” may refer to any enclosed container capable of functioning as described for the various implementations described herein.

Accordingly, various implementations disclosed herein are directed to methods for recovering a lithium (Li) end-product from a lithium-rich (Li+) solution, the method comprising: combining, within a cylinder, the lithium-rich (Li+) solution with a sodium carbonate (Na2CO3) solution to enable precipitation of solid lithium carbonate (Li2CO3) and producing a resultant sodium-rich (Na+) solution; and separating, within the cylinder, the solid lithium carbonate (Li2CO3) from a resultant sodium-rich (Na+) solution. Several such implementations may further comprise features for: introducing the lithium-rich (Li+) solution into the cylinder, heating the lithium-rich (Li+) solution to within a target temperature range, and introducing the sodium carbonate (Na2CO3) solution into the cylinder, wherein the target temperature range is between 55 degrees C. and 115 degrees C., the target temperature range is between 65 degrees C. and 105 degrees C., the target temperature range is between 75 degrees C. and 95 degrees C., the target temperature range is between 80 degrees C. and 85 degrees C., the target temperature range is between a first temperature and a second temperature where the latter is no more than 60 degrees C. greater than the first temperature, the target temperature range is between a first temperature and a second temperature where the latter is no more than 20 degrees C. greater than the first temperature, and/or the target temperature range is between a first temperature and a second temperature where the latter is no more than 10 degrees C. greater than the first temperature. Certain such implementations may also further comprise features whereby: the sodium carbonate (Na2CO3) solution is a 20%-30% concentration sodium carbonate (Na2CO3) solution; a ratio of the lithium-rich (Li+) solution to the sodium carbonate (Na2CO3) solution within the cylinder is between 1:1 and 3:1 (for example, 3.1); a ratio of the lithium-rich (Li+) solution to the sodium carbonate (Na2CO3) solution within the cylinder is maintained to be between 1:1 and 3.2:1 (for example, between 2.8:1 and 3.2:1); separating the solid lithium carbonate (Li2CO3) from a resultant sodium-rich (Na+) solution is achieved using a filter that prevents passage therethrough of the solid lithium carbonate (Li2CO3) but permits the resultant sodium-rich (Na+) solution to pass therethrough; introducing positive pressure into the cylinder to promote passage of the resultant sodium-rich (Na+) solution through the filter, the post-filter output of which provides a corresponding pressure release from the cylinder; introducing positive pressure into the cylinder is achieved at least in part by introducing air into the cylinder; and/or the air is heated within the cylinder to promote drying of the lithium carbonate (Li2CO3) within the cylinder.

Furthermore, various implementations disclosed herein also may be directed to the system for recovering a lithium (Li) end-product from a lithium-rich (Li+) solution, the system comprising: a single-cylinder for receiving and mixing the lithium-rich (Li+) solution with a sodium carbonate (Na2CO3) solution to enable precipitation of solid lithium carbonate (Li2CO3) and producing a resultant sodium-rich (Na+) solution; and a filter, within the single-cylinder, to separate the solid lithium carbonate (Li2CO3) from the resultant sodium-rich (Na+) solution. Several such implementations may further comprise: a heating jacket substantially surrounding the single-cylinder for heating internal contents of the single-cylinder; at least one input line into the single-cylinder for the lithium-rich (Li+) solution and the sodium carbonate (Na2CO3) solution; at least one output line out of the single-cylinder for the resultant sodium-rich (Na+) solution; and/or at least one input line for a positive-pressure air supply into the single-cylinder.

In addition, various implementations disclosed herein may be directed to an apparatus for recovering a lithium (Li) end-product from a lithium-rich (Li+) solution, the system comprising: a single-chamber capable of receiving, mixing, and enabling heating of the lithium-rich (Li+) solution and a sodium carbonate (Na2CO3) solution to enable precipitation of solid lithium carbonate (Li2CO3) and producing as a by-product a resultant sodium-rich (Na+) solution; and a filter subsystem within the single-cylinder means capable of separating the solid lithium carbonate (Li2CO3) from the resultant sodium-rich (Na+) solution and removing the resultant sodium-rich (Na+) solution from the single-chamber while retaining and drying the solid lithium carbonate (Li2CO3) within the single-chamber.

### Example Computing Environment

Various implementations disclosed herein may also be augmented, automated, or more efficiently and effectively operated in conjunction with computing systems and software specifically developed for these purposes.

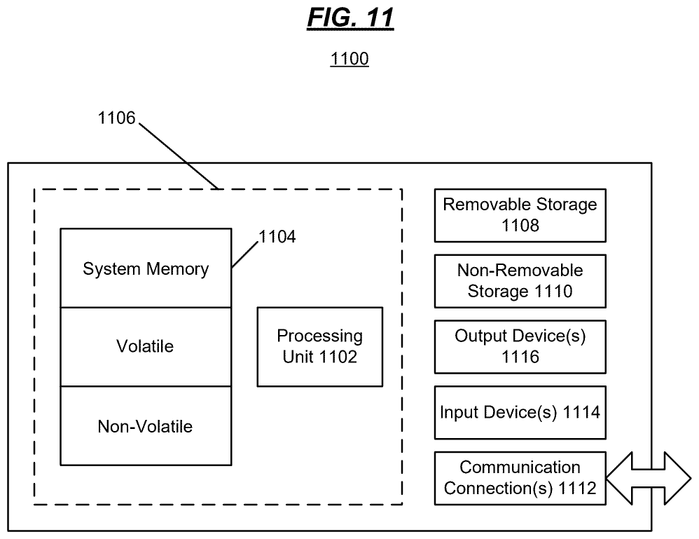

FIG. 11 is a block diagram of an example computing environment that may be used in conjunction with example implementations and aspects such as those disclosed and described with regard to the other figures presented herein and herewith. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, and so forth that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA), an analog-to-digital converter (ADC), or other programmable logic device, discrete gate or transistor logic, discrete hardware components, discrete data acquisition components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

With reference to FIG. 11, an example system for implementing aspects described herein includes a computing device, such as computing device 1100. In a basic configuration, computing device 1100 typically includes at least one processing unit 1102 and memory 1104. Depending on the exact configuration and type of computing device, memory 1104 may be volatile (such as random access memory (RAM)), non-volatile (such as read-only memory (ROM), flash memory, etc.), or some combination of the two. This basic configuration is illustrated in FIG. 11 by dashed line 1106 and may be referred to collectively as the “compute” component.

Computing device 1100 may have additional features/functionality. For example, computing device 1100 may include additional storage (removable and/or non-removable) including, but not limited to, magnetic or optical disks or tape. Such additional storage is illustrated in FIG. 11 by removable storage 1108 and non-removable storage 1110. Computing device 1100 typically includes a variety of computer readable media. Computer readable media can be any available media that can be accessed by device 1100 and may include both volatile and non-volatile media, as well as both removable and non-removable media.

Computer storage media include volatile and non-volatile media, as well as removable and non-removable media, implemented in any method or technology for storage of information such as computer readable instructions, data structures, program modules or other data. Memory 1104, removable storage 1108, and non-removable storage 1110 are all examples of computer storage media. Computer storage media include, but are not limited to, RAM, ROM, electrically erasable program read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store the information and which can be accessed by computing device 1100. Any such computer storage media may be part of computing device 1100.

Computing device 1100 may contain communication connection(s) 1112 that allow the device to communicate with other devices. Computing device 1100 may also have input device(s) 1114 such as a keyboard, mouse, pen, voice input device, touch input device, and so forth. Output device(s) 1116 such as a display, speakers, printer, and so forth may also be included. All these devices are well-known in the art and need not be discussed at length herein. Computing device 1100 may be one of a plurality of computing devices 1100 inter-connected by a network. As may be appreciated, the network may be any appropriate network, each computing device 1100 may be connected thereto by way of communication connection(s) 1112 in any appropriate manner, and each computing device 1100 may communicate with one or more of the other computing devices 1100 in the network in any appropriate manner. For example, the network may be a wired or wireless network within an organization or home or the like, and may include a direct or indirect coupling to an external network such as the Internet or the like. Moreover, PCI, PCIe, and other bus protocols might be utilized for embedding the various implementations described herein into other computing systems.

### Interpretation of Disclosures Herein

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, for example, through the use of an API, reusable controls, or the like. Such programs may be implemented in a high-level procedural or object-oriented programming language to communicate with a computer system. However, the program(s) can be implemented in assembly or machine language. In any case, the language may be a compiled or interpreted language and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Certain implementations described herein may utilize a cloud operating environment that supports delivering computing, processing, storage, data management, applications, and other functionality as an abstract service rather than as a standalone product of computer hardware, software, etc. Services may be provided by virtual servers that may be implemented as one or more processes on one or more computing devices. In some implementations, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database, etc.) of a device that is actually providing the service (e.g., computing, storage). Users may access cloud services via, for example, a web browser, a thin client, a mobile application, or in other ways. To the extent any physical components of hardware and software are herein described, equivalent functionality provided via a cloud operating environment is also anticipated and disclosed.

Additionally, a controller service may reside in the cloud and may rely on a server or service to perform processing and may rely on a data store or database to store data. While a single server, a single service, a single data store, and a single database may be utilized, multiple instances of servers, services, data stores, and databases may instead reside in the cloud and may, therefore, be used by the controller service. Likewise, various devices may access the controller service in the cloud, and such devices may include (but are not limited to) a computer, a tablet, a laptop computer, a desktop monitor, a television, a personal digital assistant, and a mobile device (e.g., cellular phone, satellite phone, etc.). It is possible that different users at different locations using different devices may access the controller service through different networks or interfaces. In one example, the controller service may be accessed by a mobile device. In another example, portions of controller service may reside on a mobile device. Regardless, controller service may perform actions including, for example, presenting content on a secondary display, presenting an application (e.g., browser) on a secondary display, presenting a cursor on a secondary display, presenting controls on a secondary display, and/or generating a control event in response to an interaction on the mobile device or other service. In specific implementations, the controller service may perform portions of methods described herein.

### Anticipated Alternatives

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Moreover, it will be apparent to one skilled in the art that other implementations may be practiced apart from the specific details disclosed above.

The drawings described above and the written description of specific structures and functions below are not presented to limit the scope of what has been invented or the scope of the appended claims. Rather, the drawings and written description are provided to teach any person skilled in the art to make and use the inventions for which patent protection is sought. Those skilled in the art will appreciate that not all features of a commercial implementation of the inventions are described or shown for the sake of clarity and understanding. Skilled artisans will further appreciate that block diagrams herein can represent conceptual views of illustrative circuitry embodying the principles of the technology, and that any flow charts, state transition diagrams, pseudocode, and the like represent various processes which may be embodied in computer readable medium and so executed by a computer or processor, whether or not such computer or processor is explicitly shown. The functions of the various elements including functional blocks may be provided through the use of dedicated electronic hardware as well as electronic circuitry capable of executing computer program instructions in association with appropriate software. Persons of skill in this art will also appreciate that the development of an actual commercial implementation incorporating aspects of the inventions will require numerous implementation-specific decisions to achieve the developer's ultimate goal for the commercial implementation. Such implementation-specific decisions may include, and likely are not limited to, compliance with system-related, business-related, government-related, and other constraints, which may vary by specific implementation, location, and from time to time. While a developer's efforts might be complex and time-consuming in an absolute sense, such efforts would be, nevertheless, a routine undertaking for those of skill in this art having benefit of this disclosure.

It should be understood that the implementations disclosed and taught herein are susceptible to numerous and various modifications and alternative forms. Thus, the use of a singular term, such as, but not limited to, “a” and the like, is not intended as limiting of the number of items. Also, the use of relational terms, such as, but not limited to, “top,” “bottom,” “left,” “right,” “upper,” “lower,” “down,” “up,” “side,” and the like, are used in the written description for clarity in specific reference to the drawings and are not intended to limit the scope of the invention or the appended claims. For particular implementations described with reference to block diagrams and/or operational illustrations of methods, it should be understood that each block of the block diagrams and/or operational illustrations, and combinations of blocks in the block diagrams and/or operational illustrations, may be implemented by analog and/or digital hardware, and/or computer program instructions. Computer program instructions for use with or by the implementations disclosed herein may be written in an object-oriented programming language, conventional procedural programming language, or lower-level code, such as assembly language and/or microcode. The program may be executed entirely on a single processor and/or across multiple processors, as a stand-alone software package or as part of another software package. Such computer program instructions may be provided to a processor of a general-purpose computer, special-purpose computer, ASIC, and/or other programmable data processing system. The executed instructions may also create structures and functions for implementing the actions specified in the mentioned block diagrams and/or operational illustrations. In some alternate implementations, the functions/actions/structures noted in the drawings may occur out of the order noted in the block diagrams and/or operational illustrations. For example, two operations shown as occurring in succession, in fact, may be executed substantially concurrently or the operations may be executed in the reverse order, depending on the functionality/acts/structure involved.

The term “computer-readable instructions” as used above refers to any instructions that may be performed by the processor and/or other components. Similarly, the term “computer-readable medium” refers to any storage medium that may be used to store the computer-readable instructions. Such a medium may take many forms, including, but not limited to, non-volatile media, volatile media, and transmission media. Non-volatile media may include, for example, optical or magnetic disks, such as the storage device. Volatile media may include dynamic memory, such as main memory. Transmission media may include coaxial cables, copper wire, and fiber optics, including wires of the bus. Transmission media may also take the form of acoustic or light waves, such as those generated during radio frequency (RF) and infrared (IR) data communications. Common forms of computer-readable media may include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EPROM, any other memory chip or cartridge, a carrier wave, or any other medium from which a computer can read.

In the foregoing description, for purposes of explanation and non-limitation, specific details are set forth-such as particular nodes, functional entities, techniques, protocols, standards, etc.—in order to provide an understanding of the described technology. In other instances, detailed descriptions of well-known methods, devices, techniques, etc. are omitted so as not to obscure the description with unnecessary detail. All statements reciting principles, aspects, embodiments, and implementations, as well as specific examples, are intended to encompass both structural and functional equivalents, and such equivalents include both currently known equivalents as well as equivalents developed in the future, i.e., any elements developed that perform the same function, regardless of structure. While the disclosed implementations have been described with reference to one or more particular implementations, those skilled in the art will recognize that many changes may be made thereto. Therefore, each of the foregoing implementations and obvious variations thereof is contemplated as falling within the spirit and scope of the disclosed implementations, which are set forth in the claims presented below.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

What is claimed:

1. A method for recovering a lithium (Li) end-product from a lithium-rich (Li+) solution, the method comprising:
combining, within a cylinder, the lithium-rich (Li+) solution with a sodium carbonate (Na2CO3) solution to enable precipitation of solid lithium carbonate (Li2CO3) and producing a resultant sodium-rich (Na+) solution; and
separating, within the cylinder, the solid lithium carbonate (Li2CO3) from a resultant sodium-rich (Na+) solution.

2. The method of claim 1, wherein combining, within a cylinder, the lithium-rich (Li+) solution with the sodium carbonate (Na2CO3) solution further comprises:
introducing the lithium-rich (Li+) solution into the cylinder;
heating the lithium-rich (Li+) solution to within a target temperature range; and
introducing the sodium carbonate (Na2CO3) solution into the cylinder.

3. The method of claim 2, wherein the target temperature range is between 55 degrees C. and 115 degrees C.

4. The method of claim 2, wherein the target temperature range is between 65 degrees C. and 105 degrees C.

5. The method of claim 2, wherein the target temperature range is between 75 degrees C. and 95 degrees C.

6. The method of claim 2, wherein the target temperature range is between 80 degrees C. and 85 degrees C.

7. The method of claim 2, wherein the target temperature range is between a first temperature and a second temperature where the latter is no more than 20 degrees C. greater than the first temperature.

8. The method of claim 2, wherein the target temperature range is between a first temperature and a second temperature where the latter is no more than 10 degrees C. greater than the first temperature.

9. The method of claim 2, wherein the sodium carbonate (Na2CO3) solution is a 20%-30% concentration sodium carbonate (Na2CO3) solution.

10. The method of claim 2, wherein a ratio of the lithium-rich (Li+) solution to the sodium carbonate (Na2CO3) solution within the cylinder is 3:1.

11. The method of claim 2, wherein a ratio of the lithium-rich (Li+) solution to the sodium carbonate (Na2CO3) solution within the cylinder is maintained to be between 2.8:1 and 3.2:1.

12. The method of claim 1, wherein separating the solid lithium carbonate (Li2CO3) from a resultant sodium-rich (Na+) solution is achieved using a filter that prevents passage therethrough of the solid lithium carbonate (Li2CO3) but permits the resultant sodium-rich (Na+) solution to pass therethrough.

13. The method of claim 12, further comprising introducing positive pressure into the cylinder to promote passage of the resultant sodium-rich (Na+) solution through the filter, the post-filter output of which provides a corresponding pressure release from the cylinder.

14. The method of claim 13, wherein introducing positive pressure into the cylinder is achieved at least in part by introducing air into the cylinder.

15. The method of claim 14, wherein the air is heated within the cylinder to promote drying of the lithium carbonate (Li2CO3) within the cylinder.

16. A system for recovering a lithium (Li) end-product from a lithium-rich (Li+) solution, the system comprising:
a single-cylinder for receiving and mixing the lithium-rich (Li+) solution with a sodium carbonate (Na2CO3) solution to enable precipitation of solid lithium carbonate (Li2CO3) and producing a resultant sodium-rich (Na+) solution; and
a filter, within the single-cylinder, to separate the solid lithium carbonate (Li2CO3) from the resultant sodium-rich (Na+) solution.

17. The system of claim 16, further comprising a heating jacket substantially surrounding the single-cylinder for heating internal contents of the single-cylinder.

18. The system of claim 16, further comprising:
at least one input line into the single-cylinder for the lithium-rich (Li+) solution and the sodium carbonate (Na2CO3) solution; and
at least one output line out of the single-cylinder for the resultant sodium-rich (Na+) solution.

19. The system of claim 16, further comprising at least one input line for a positive-pressure air supply into the single-cylinder.

20. An apparatus for recovering a lithium (Li) end-product from a lithium-rich (Li+) solution, the system comprising:
a single-chamber capable of receiving, mixing, and enabling heating of the lithium-rich (Li+) solution and a sodium carbonate (Na2CO3) solution to enable precipitation of solid lithium carbonate (Li2CO3) and producing as a by-product a resultant sodium-rich (Na+) solution; and
a filter subsystem within the single-cylinder means capable of separating the solid lithium carbonate (Li2CO3) from the resultant sodium-rich (Na+) solution and removing the resultant sodium-rich (Na+) solution from the single-chamber while retaining and drying the solid lithium carbonate (Li2CO3) within the single-chamber.
